(19) United States
(12) Patent Application Publication
(10) Pub. No.: US 2026/0253350 A1
(43) Pub. Date: Aug. 27, 2026

(54) MULTIVIEW INPAINTING OF THREE-DIMENSIONAL OBJECTS

(71) Applicant: Adobe Inc., San Jose, CA (US)

(72) Inventors: Thibault Groueix, San Francisco, CA (US); Vladimir Kim, Seattle, WA (US); Matheus Abrantes Gadelha, Amherst, MA (US); Amir Zvi Barda, Rishon Lezion (IL)

(73) Assignee: Adobe Inc., San Jose, CA (US)

(21) Appl. No.: 19/063,104

(22) Filed: Feb. 25, 2025

(51) Int. Cl. G06T 19/20; G06T 5/60; G06T 5/77; G06T 15/20; G06T 17/20

(52) U.S. Cl. CPC G06T 19/20; G06T 5/60; G06T 5/77; G06T 15/20; G06T 17/20; G06T 2207/20081; G06T 2210/12

(57) ABSTRACT

Techniques for multiview inpainting of three-dimensional (3D) objects are described. In one or more examples, a processing device receives a first three-dimensional (3D) object, a mask indicating a region of the first 3D object in which to inpaint a second 3D object, and a text description of the second 3D object. A first machine-learning model generates multiple two-dimensional (2D) views of the first 3D object and the mask. For each 2D view, the first machine-learning model generates a third 3D object that includes the second 3D object inpainted on the first 3D object. A second machine-learning model reconstructs a 3D representation of the third 3D object from the multiple 2D views, which is presented for display in a user interface.

### BACKGROUND

Inpainting refers to generating “fill” for regions within a three-dimensional (3D) digital object. Inpainting, for instance, is usable in support of object removal, object addition, object swapping, hole filling, visual artifact correction (e.g., to remove “distractors”), and so forth for the digital object. To do so, an inpainter module of a computing device generates color values for voxels within a corresponding region of the digital object, i.e., the object to be added, the hole to be filled, the object to be removed, and so forth.

There are a variety of different types of inpainter modules that utilize 3D generative techniques for creating and editing 3D content. These conventional techniques allow users to control the generation process with as little as a single text prompt. While text prompts provide a simple interface, these conventional techniques lack fine control over the generated 3D content. Specifically, these conventional techniques do not provide the ability to generate an object in a specific location or with a specific size over or within a pre-existing 3D model.

### SUMMARY

Multiview inpainting techniques for 3D objects are described. These techniques are usable by an inpainting system to generate inpainted 3D objects with high-quality results quickly. Instead of directly editing 3D objects using generative models, the inpainting system trains a machine-learning model to create 2D images of the inpainted 3D objects from different viewpoints. The inpainting system then uses another machine-learning model to reconstruct the inpainted 3D object from the 2D images.

In one or more examples, the inpainting system uses a custom training strategy to develop a multiview-consistent inpainting diffusion model. A training dataset of multiview-consistent masks is generated to avoid problems resulting from occlusions. For example, the training dataset is designed to support various editing modes with different levels of granularity to provide a more robust diffuser. The training dataset leverages the priors learned by the text-conditioned image generator and fine tunes the model to become multiview consistent. In addition to providing greater user control and greatly reduced runtimes, the described inpainting system is agnostic to the underlying 3D representation format, supporting various formats.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

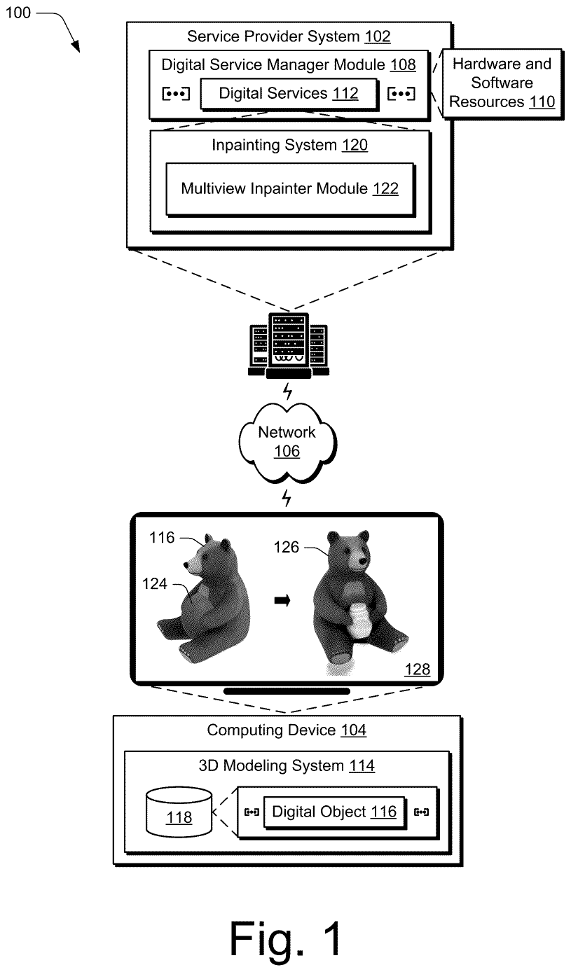

FIG. 1 is an illustration of a digital medium environment in an example implementation that is operable to employ techniques for multiview inpainting of 3D objects as described herein.

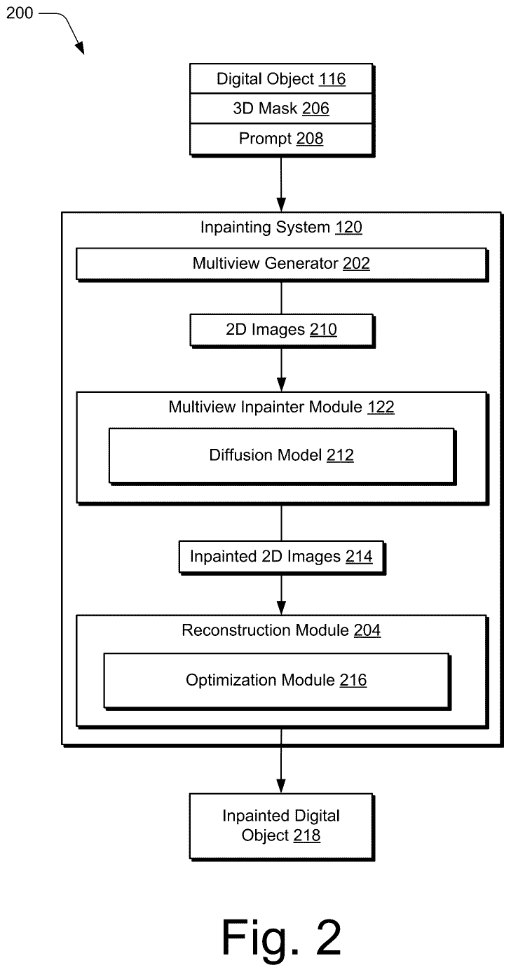

FIG. 2 depicts a system in an example implementation showing operation of an inpainting system of FIG. 1 in greater detail as implementing multiview inpainting of 3D objects.

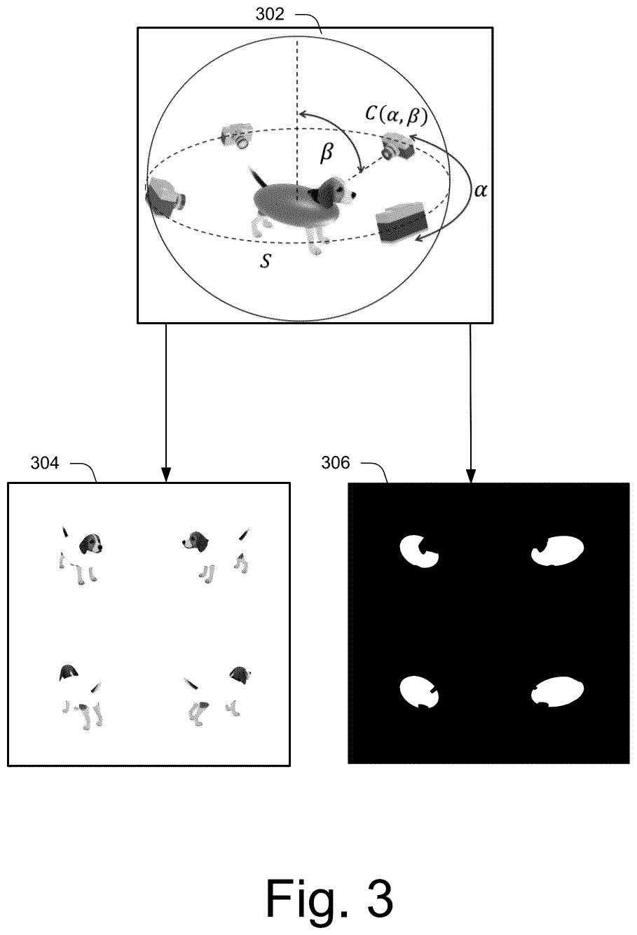

FIG. 3 depicts an example implementation showing generation of multiview representations in greater detail.

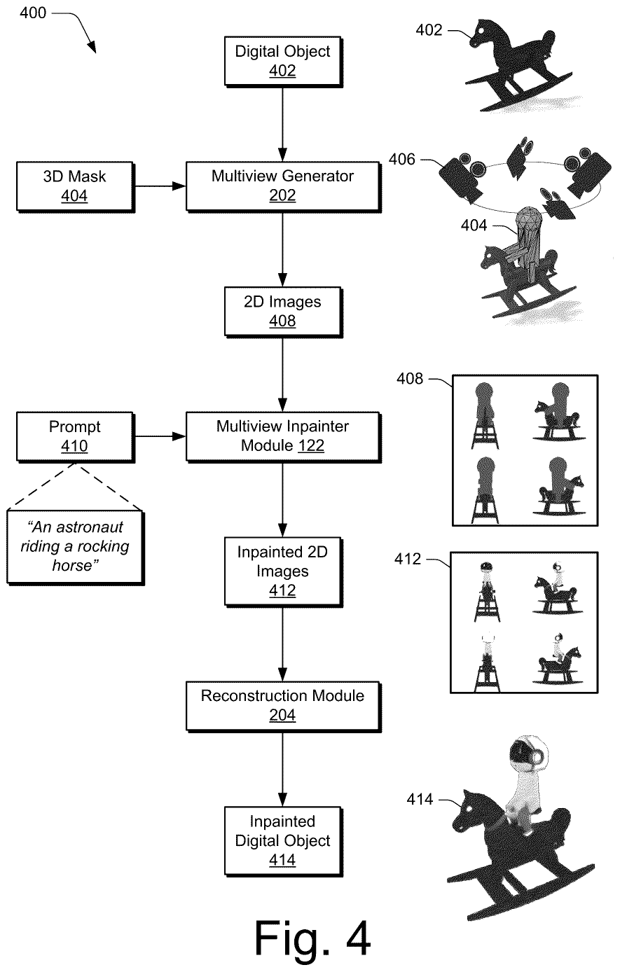

FIG. 4 depicts an example implementation showing operation of an inpainting system to provide multiview inpainting of 3D objects.

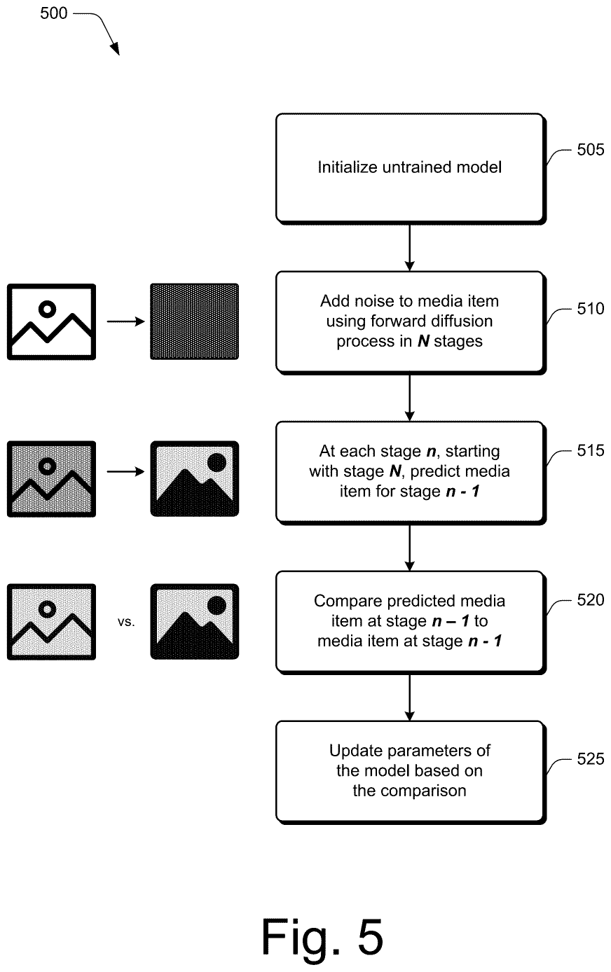

FIG. 5 shows an example of a method for training a diffusion model according to aspects of the present disclosure.

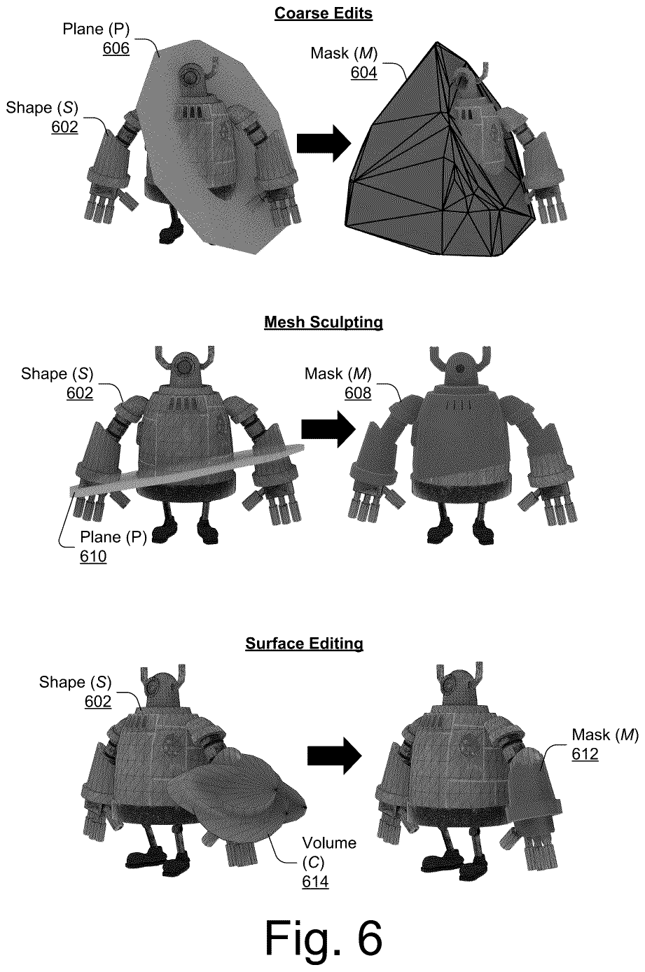

FIG. 6 illustrates example mask types generated for training a diffusion model according to aspects of the present disclosure.

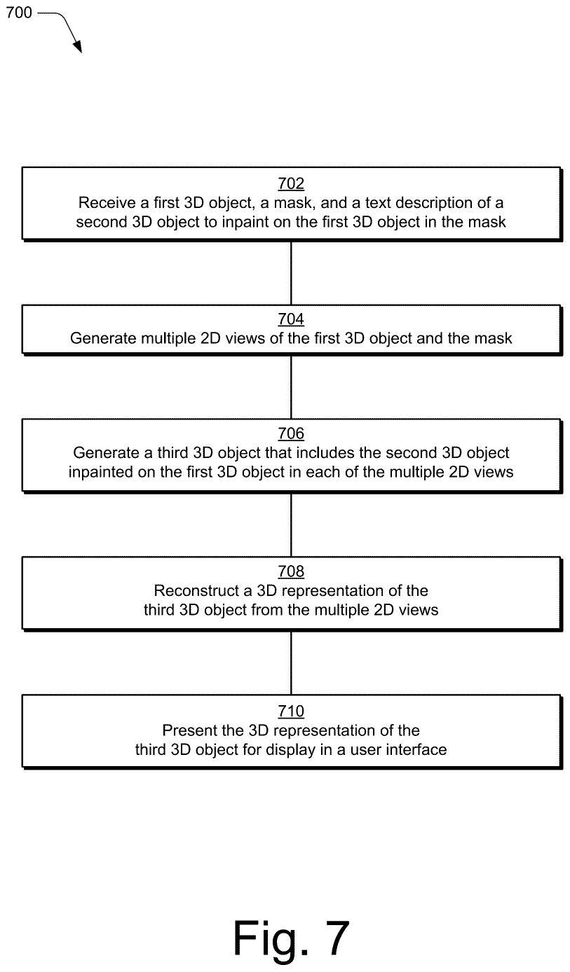

FIG. 7 is a flow diagram depicting an algorithm as a step-by-step procedure in an example implementation of operations performable for accomplishing a result of multiview inpainting of 3D objects.

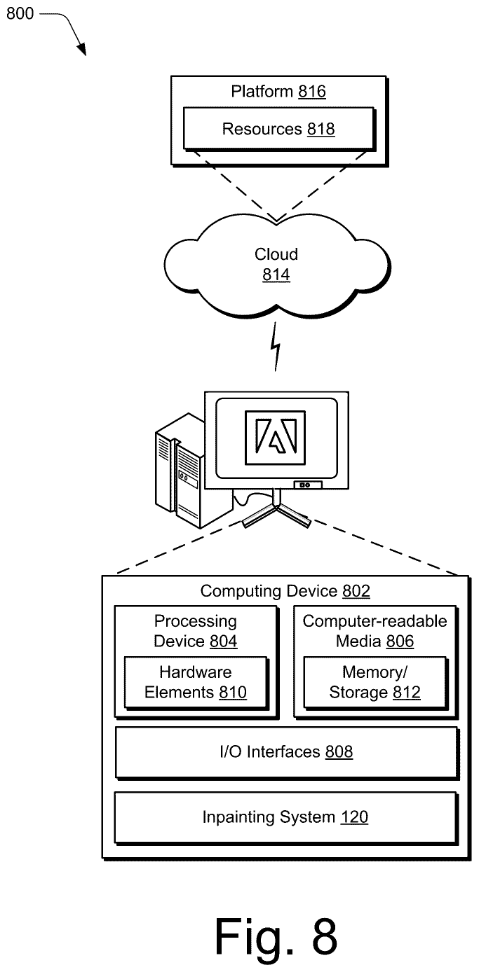

FIG. 8 illustrates an example system including various components of an example device that is implemented as any type of computing device as described and/or utilize with reference to FIGS. 1-7 to implement embodiments of the techniques described herein.

### DETAILED DESCRIPTION

### Overview

Content processing systems often use 3D modeling applications to generate, manipulate, and render 3D digital objects in a virtual space. Such applications, for example, allow users to construct digital representations of objects by defining properties of the objects, such as a geometric shape or orientation, surface textures, materials, lighting properties, and so forth. Accordingly, 3D modeling applications are utilized in a variety of industries. However, conventional editing or inpainting techniques (e.g., to add, alter, or remove objects) within 3D modeling applications remain challenging, particularly for users with limited experience.

3D modeling applications have recently employed artificial intelligence (AI) guided 3D generative models to create and edit 3D digital objects, allowing users to control the generation process with as little as a single text or voice prompt. Such prompts provide an easy interface for users to generate various 3D objects (e.g., via text or audio input). However, these conventional techniques lack fine control over generating a specific object in a specific location over or on a pre-existing 3D model. Consider an example in which a user wishes to edit a 3D model of a bear so that the bear is holding a honey pot. Even if the user constructs a complex and detailed prompt, conventional techniques cannot edit the original 3D model to insert the honey pot into the bear's arm in a visually realistic manner. In addition, these conventional techniques are often computationally expensive, sometimes taking tens of minutes to multiple hours to edit 3D objects.

Accordingly, multiview inpainting techniques of 3D objects are described to address these and other technical challenges. These techniques are usable by an inpainting system to perform 3D generative editing to produce high-quality results in seconds. The techniques cast 3D editing as a multiview image inpainting problem to reduce the computational expense.

The inpainter system, for example, is configurable to receive a 3D object as input, a 3D mask marking the region to be filled (or edited), and a prompt to guide the generation. The inpainter system then renders the masked object's four canonical 2D views (e.g., front, rear, left, and right). A multiview inpainting network fills the 3D mask based on the prompt, with an output providing the four canonical 2D views of the filled 3D object. The inpainter system then uses a 3D reconstructor to convert the multiview representation into a 3D model of the filled 3D object.

Continuing the previous bear example, the inputs include a 3D model of the bear, a 3D mask of an area between the bear's arms (front legs), and a text prompt asking for “a bear holding a honey pot.” The inpainter system first generates a front, rear, left, and right view of the 3D bear and the 3D mask. Using these 2D views, the multiview inpainting network fills the 3D mask with a honey pot and outputs the 2D views of the bear holding a honey pot. A 3D reconstructor then generates the 3D model of the bear holding the honey pot.

In this way, the inpainting system supports localized edits based on specified constraints present in user prompts. Thus, the techniques described herein increase efficiency and user satisfaction in a 3D modeling scenario. Further discussion of these and other examples and advantages are included in the following sections and shown using corresponding figures.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Inpainting Environment

FIG. 1 illustrates an environment 100 in an example implementation that is operable to employ techniques for multiview inpainting of 3D objects as described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 8.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, digital content creation and editing service, and so on. Accordingly, in the illustrated example, a 3D modeling system 114 is utilized by the computing device 104 to access the one or more digital services 112 via the network 106. A result of processing using the digital services 112 is then returned to the computing device 104 via the network 106.

The computing device 104 is illustrated as including a plurality of digital objects, an example of which is illustrated as digital object 116 as stored in a storage device 118. The 3D modeling system 114 is then configured to execute one or more operations to edit the digital object 116, including creating the digital object 116, making a change to the digital object 116, and so forth.

Inpainting refers to techniques usable to generate color values for voxels within a region of a digital object. Inpainting, for instance, is performable using one or more algorithms, rule-based techniques, machine learning, generative artificial intelligence, and so on. Functionality usable to implement inpainting is represented by a multiview inpainter module that is executed locally at the computing device 104 and a multiview inpainter module 124 that is implemented remotely by the service provider system 102 as part of the digital services 112. The multiview inpainter modules 122, 124 are executable to implement inpainting techniques to generate or edit digital objects 116.

As previously described, conventional techniques focus on localized generation of 3D objects using 3D inpainting approaches, which fill in masked-out content in a 3D object, conditioned on a textual description of the desired fill-in, similar to 2D inpainting. These conventional 3D inpainting techniques cannot be integrated into production pipelines because they involve long runtimes and have low-quality outputs. These conventional techniques generally optimize a 3D model by distilling knowledge from a generative model for 2D images via a variant of score distillation sampling (SDS), which is a slow optimization process that relies on running an image diffusion model over multiple renderings of the 3D object and back-propagating gradients. In addition, SDS optimization also tends to produce inaccurate and fuzzy results.

Accordingly, to address these and other technical challenges the inpainting system 120 avoids directly optimizing a 3D object. Instead, the inpainting system 120 trains an image generator to create 2D images of the inpainted 3D object from canonical viewpoints and then reconstructs the newly-inpainted 3D object in a post process via either a feed-forward prediction or lightweight optimization. By doing so, the inpainting system 120 avoids both the slow runtimes as well as masking issues that plague conventional techniques.

The multiview inpainter module 122 takes as input a 3D digital object 116 (e.g., a bear 126) along with a 3D mask 124 and a text prompt (e.g., “a bear holding a honey pot”). The multiview inpainter module 124 uses a multiview inpainting diffusion model to consistently paint the mask in four rendered views of the digital object 116. A reconstructor is used on the multiview output to provide a NeRF, Gaussian Splat, or a mesh. The mesh output is usable along with adaptive remeshing to ensure the unmasked region is preserved (e.g., topology and spatial coordinates). The described multiview inpainting techniques are orders of magnitude faster than conventional techniques for generative 3D editing. For example, the described techniques take as little as several seconds. In this way, the inpainting system 120, through use of the multiview inpainter modules 122, 124 improves accuracy in achieving a desired result as well as optimizes computational resource consumption, which is not possible in conventional techniques. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Multiview Inpainter

FIG. 2 depicts a system in an example implementation 200 showing the operation of an inpainting system 120 of FIG. 1 in greater detail as implementing multiview inpainting of 3D objects. The inpainting system 120 includes a multiview generator 202, the multiview inpainter module 122 of FIG. 1, and a reconstruction module 204.

The inputs to the inpainting system 120 include tuples [symbol] S, M, y [symbol] of a digital object 116 (e.g., represented by S), a 3D mask 206 (e.g., represented by M), and a prompt 208 (e.g., represented by y). The digital object 116, S, is a 3D shape configurable as a mesh, Gaussian Splat, Neural Radiance Field (NeRF), point cloud, voxel grid, octree, or another 3D representation format. The 3D mask 206, M, represents an area to be covered or modified in accordance with the prompt 208, y. The prompt 208 includes a natural language description of the object or effect to be applied to the digital object 116, S, in the area covered by the 3D mask 206, M, to create a new or edited shape, Ŝ.

User inputs, for instance, is received via a user interface 128 as shown in FIG. 1 to specify the digital object 116, the 3D mask 206, and the prompt 208. For example, the digital object 116 is selectable from a database of pre-existing digital objects, a storage location associated with the computing device 104, or an output from a machine-learning model configurable to generate 3D objects from a text prompt. Similarly, the 3D mask 206 is selectable from a database of pre-existing objects with size and shape modifications performed using one or more selection tools. The prompt 208 is received as a typed or spoken input in a natural language format.

The multiview generator 202 renders a set of 2D images 210 of the digital object 116 with the 3D mask 206. The multiview generator 202 acts as a rendering operator [symbol] that generates a scene [symbol] from a viewpoint π. In particular, a color RGB image, [symbol] , and binary mask, [symbol] , are generated for each viewpoint. In one implementation, the multiview generator 202 is referred to as an [symbol] operator to indicate that just the visible pixels belonging to the shape U are rendered, assuming U∈ [symbol] . Using the [symbol] operator, the multiview representations are defined as:

$${I}_{k} ( U , V ) := {⊕}_{π ∈ Π} {ℛ}_{k}^{U} \{ \{ U \} ⋃ \{ V \} ; π \}$$

where ⊕ concatenates the images in a two-by-two grid, k is rendering modality (color or binary), and

$$Π = \{ C ( α , \frac{π}{4} ) \vert α ∈ \{ 0 , \frac{π}{2} , π , 3 \frac{π}{2} \} \} ; C ( α , β )$$

is a function that returns a viewpoint configuration corresponding to a camera pointing at the origin of the coordinate system and positioned on the surface of a canonical sphere according to azimuth α and elevation β. Using this operator, the 2D images 210 are defined as I_{c}(S,M) and I_{b}(S,M). I_{c}(S,M) provides an image containing the visible pixels of S in the scene {S}∪{M} rendered from multiple views organized in a grid. Similarly, I_{b}(S,M) provides a binary rendering of the visible pixels of M. An example of the 2D images 210 are presented in FIG. 3.

FIG. 3 depicts an example implementation showing generation of multiview representations in greater detail. In FIG. 3, setup 302 includes the digital object 116, S, as a puppy and the 3D mask 206, M, as an ellipsoid. The ellipsoid, for example, represents the area or surface of the puppy on which a clothing item (e.g., a sweater) or another object will be inpainted. The 2D images 210 are generated from four different viewpoint configurations, C, illustrated in setup 302 as cameras. Each viewpoint configuration points to the origin of the coordinate system that originates from the center of the digital object 116 and is positioned on the surface of a canonical sphere according to an azimuth angle, α, and an elevation angle, β. Each viewpoint configuration as an azimuth and/or elevation angle that is different from the other viewpoint configurations. In one example, the azimuth angle for the four viewpoint configurations is equal to FIG. 1

$$\{ 0 , \frac{π}{2} , π , 3 \frac{π}{2} \}$$

and the elevation angle is equal to π/4. In other implementations, different values are used for the azimuth and/or elevation angles. Although setup 302 indicates that the multiview generator 202 uses four viewpoint configurations, additional or fewer viewpoints (e.g., nine) are utilized in other implementations.

From the setup 302, the multiview generator 202 generates the 2D images 210 in the form of color image 304, I_{c}(S,M), and binary image 306, I_{b}(S,M). As described above, the color image 304 provides a two-by-two grid of the visible pixels of the puppy (e.g., a portion of the puppy not obscured by the ellipsoid) from different viewpoints. The binary image 306 provides a two-by-two grid of the visible pixels of the ellipsoid from the different viewpoints in a binary mask. The number of sub-images included in the color image 304 and the binary image 306 is adjusted based on the number of viewpoint configurations utilized by the multiview generator 202.

The inpainting system 120 then provides the 2D images 210 (e.g., color image 304, I_{c}(S,M), and binary image 306, I_{b}(S,M)) to the multiview inpainter module 122, which includes a diffusion model 212, ∈_{θ}. In one implementation, the diffusion model 212 is a pretrained text-conditioned image generator (or text-to-image diffusion model). As detailed with respect to FIG. 4, the multiview inpainter module 122 utilizes a training strategy that leverages the priors learned by the diffusion model 212. In particular, the multiview inpainter module 122 uses a custom dataset and training approach to make the diffusion model 212 multiview consistent.

Given the color image 304, I_{c}(S,M), and binary image 306, I_{b}(S,M)), the diffusion model 212 generates an inpainted multiview representation Î_{c}, which includes multiple inpainted 2D images 214 in a similar grid (e.g., two-by-two grid) as the input with the same viewpoint configurations. The diffusion model 212 is a latent diffuser with the diffusion occurring in a four-dimensional latent space instead of an RGB space. The multiview inpainter module 122 uses a pretrained vector quantized variational autoencoder (VQ-VAE) to encode and decode images (e.g., the 2D images 210) from the RGB space. The VQ-VAE maps the 2D images 210 to a sequence of discrete codes, compressing the high-dimensional image data into a lower-dimensional, discrete representation to reduce the computational cost and memory requirements for the diffusion model 212. After the diffusion model 212 inpaints onto the digital object 116, the VQ-VAE decoder reconstructs the inpainted 2D images 214 in the RGB space from the latent representation of the inpainted digital object.

The reconstruction module 204 uses a posed multiview reconstruction process Φ to generate the inpainted digital object 218, Ŝ, from the inpainted 2D images 214: Ŝ=Φ(Î_{c}). Different reconstructors Φ yield different applications and tradeoffs. For example, the reconstruction module 204 provides fast learning-based reconstruction from posed multiview images using various representations, like NeRFs, meshes, and Gaussian Splats.

In another implementation, the reconstruction module 204 includes an optimization module 216 that slows the reconstruction process, but provides desirable optimization properties like geometric regularization and preservation of the original asset attributes (e.g., color, connectivity, UVs, and so forth).

FIG. 4 depicts an example implementation 400 showing operation of an inpainting system to provide multiview inpainting of 3D objects. The multiview generator 202 receives as inputs a digital object 402 and a 3D mask 404.

In this implementation 400, the digital object 402 is a rocking horse. In one implementation, the rocking horse is generated using generative artificial intelligence (e.g., a diffusion model) from a user prompt (e.g., “generate a 3D model of a rocking horse”). In other implementations, the rocking horse is selected from a database of digital objects, imported from an external file or source, or generated by the user within the 3D modeling system 114. The rocking horse model is represented using meshes, Gaussian Splats, or NeRFs.

The 3D mask 404 is a rough outline of the object to be inpainted onto the rocking horse (e.g., the digital object 402). In implementation 400, the 3D mask 404 approximates the shape of a person riding the rocking horse. The 3D mask 404 is selected from a set of pre-generated masks in one implementation. For example, the user selects the humanoid mask from a database and scales and/or adjusts it to approximate the object to be inpainted onto the rocking horse. In another implementation, the user generates the humanoid mask from several elemental mask shapes. In yet another implementation, a machine-learning model generates the 3D mask 404 based on a user prompt, which the user scales and positions in a desired location on the rocking horse.

Using four camera viewpoints 406, the multiview generator 202 outputs 2D images 408. In implementation 400, the camera viewpoints 406 are taken from an elevation angle of about 45 degrees off a horizontal surface and from azimuth angles separated by about 90 degrees. The 2D images 408 show the rocking horse from the multiple camera viewpoints 406 in a two-by-two grid as occluded by the humanoid mesh. Specifically, the occluded rocking horse is shown from a front, rear, left, and right view.

The multiview inpainter module 122 receives as inputs the 2D images 408 and a prompt 410. Here, the prompt 410 requests “an astronaut riding a rocking horse.” The diffusion model 212 inpaints an astronaut onto the rocking horse in the 2D images 408 to generate inpainted 2D images 412, which are in the same viewpoints as the 2D images 408. For example, the inpainted 2D images 412 show the astronaut from the front, rear, left, and right. The reconstruction module 204 reconstructs the rocking horse and the astronaut from the inpainted 2D images 412 to generate the inpainted digital object 414 as a 3D model. The inpainted digital object 414 is generated using meshes, Gaussian Splats, or NeRFs, which is user selectable and variable from the representation of the digital object 402.

FIG. 5 shows an example of a method 500 for training a diffusion model according to aspects of the present disclosure. The method 500 represents an example for training a diffusion model 212 as described above with reference to FIG. 2. In some examples, these operations are performed by a system including a processor executing a set of codes to control functional elements of an apparatus.

Additionally, or alternatively, certain processes of method 500 is performed using special-purpose hardware. Generally, these operations are performed according to the methods and processes described in accordance with aspects of the present disclosure. In some cases, the operations described herein are composed of various substeps or are performed in conjunction with other operations.

At operation 505, the user initializes an untrained model (e.g., a text-to-image diffusion model). Initialization includes defining the architecture of the model and establishing initial values for the model parameters. In some cases, the initialization includes defining hyper-parameters such as the number of layers, the resolution and channels of each layer blocks, the location of skip connections, and the like.

In other cases, the initialization includes utilizing a previously-trained or previously-defined model. The diffusion model 212 is trained to achieve multiview-consistent inpainting using a customized training strategy with a particular dataset of 3D masks for 3D inpainting. The mask dataset includes multiview-consistent masks to avoid issues that result from occlusions. In addition, the mask dataset is generated to support several editing modes with different levels of granularity. The training strategy is designed to leverage the priors learned by a pretrained, text-conditioned image generator as opposed to fine-tuning a multiview diffuser to perform inpainting.

At operation 510, the system adds noise to a media item using a forward diffusion process in N stages. In some cases, the forward diffusion process is a fixed process where Gaussian noise is successively added to media item. In latent diffusion models, the Gaussian noise is successively added to features in a latent space.

In one implementation of training, an image x is sampled from the dataset, with condition c (e.g., text, mask, or depth), a time step t between 0 and T, and a noise ∈~ [symbol] (0,I) is injected to x to create a noisy image \tilde{x}(t):

$$\tilde{x} ( t ) = \sqrt{α ( t )} \cdot x + \sqrt{1 - α ( t )} \cdot ϵ ,$$

where α(t) controls the amount of noise to inject (e.g., α(0)=1 is no noise and α(T)=0 is pure noise). A denoising U-Net ∈_{θ} is trained to denoise \tilde{x}(t) by minimizing the diffusion loss:

$${L}_{diff} = ω ( t ) {‖ {ϵ}_{θ} ( \tilde{x} ( t ) ; t , c ) - x ‖}^{2} ,$$

where ω(t) is a scheme to scale the gradients according to t. Once ∈_{θ} is trained, ∈_{θ}(\tilde{x}(t);t,c) is the projection of \tilde{x}(t) to the manifold of images defined by the training dataset.

In this implementation, the training starts from pure noise \tilde{x}(T) and follows the direction of the manifold defined by ∈_{θ}(\tilde{x}(t);t,c). A sampler (e.g., an Euler scheduler) is used to discretize this trajectory into a discrete number of steps (e.g., 29 steps). To generate two-by-two consistent views, the training dataset is filled with a distribution of two-by-two images. To create this dataset, a curated list of high-quality objects (e.g., about five thousand objects) is obtained and grouped with high-quality captions for each 3D object.

The condition c is composed on the text prompt y, the base image with holes, and the inpainting mask (e.g., c={y, I_{c}(S,M), I_{b}(M,S)}). For latent models, I_{c}(S,M) is passed through the encoder ε of the VQ-VAE, concatenated with the downsampled version of the mask I_{b}(M,S), and the noisy latents \tilde{x}(t), leading to a nine-channel tensor input to the denoising U-Net ∈_{θ}, along with the encoding of the text condition. During training, the mask is randomly dropped ten percent of the time to fall back to multiview diffusion training.

At operation 515, the system at each stage n, starting with stage N, uses a reverse diffusion process to predict the output or features at stage n−1. For example, the reverse diffusion process predicts the noise that was added by the forward diffusion process, and the predicted noise is removed from the noise input to obtain the predicted output. In some cases, an original media item is predicted at each stage of the training process.

At operation 520, the system compares predicted output (or features) at stage n−1 to an actual media item (or features), such as the output at stage n−1 or the original input. For example, given observed data x, the diffusion model is trained to minimize the variational upper bound of the negative log-likelihood−log p₇₄ (x) of the training data.

At operation 525, the system updates parameters of the model based on the comparison. For example, parameters of a U-Net are updated using gradient descent. Time-dependent parameters of the Gaussian transitions are also learnable.

FIG. 6 illustrates example mask types generated for training a diffusion model according to aspects of the present disclosure. As discussed above, the training dataset for the diffusion model 212 includes multiview masks that are 3D consistent. The binary masks used to train the multiview inpainting model are obtained by rendering 3D shapes. Consider the example illustrated in FIG. 3. Although M is an ellipsoid, the multiview representation I_{b}(M,S) of the mask is not—the mask has occlusions from its interaction with S.

The diffusion model 212 is trained based on a set of shapes [symbol] . For each shape S∈ [symbol] , a set of 3D masks [symbol] is created. Using the 3D masks, the training dataset [symbol] is defined as:

$$𝒥 := \{ 〈 {I}_{c} ( S , ϕ ) , {I}_{c} ( S , M ) , {I}_{b} ( M , S ) 〉 , {y}_{S} \}$$

where S∈ [symbol] , M∈ [symbol] , and I_{c}(S,φ), I_{c}(S,M), I_{b}(M,S) are the color ground-truth image, color input image, and binary input mask, respectively. yₛ is a text prompt describing the shape S obtained from a vision-language model.

The dataset of 3D masks is generated with a distribution of training masks that follows the distribution of edits that user are anticipated to make. As a result, the three types of masks are illustrated in FIG. 6 that correspond to three types of editing.

A first type of edit involves coarse edits. In this scenario, the inpainted part of the shape S 602 is fully contained inside the mask M 604. The mask M 604 is computed by randomly sampling a part of S and taking its convex hull. To select this part, a plane P 606 passing through the shape S 602 is randomly sampled, effectively splitting the shape S 602 into two parts, and one part is randomly selected. More precisely, a random point p inside the bounding box of the shape S 602 and a random direction n are sampled. The plane P 606 passing through p with normal n is defined by {x∈ [symbol] ³|x·p=p·n}. The mask M 604 is defined as the convex hull of each face midpoint that is above the plane P 606, i.e.,

$$M = \{ f = ( {v}_{1} , {v}_{2} , {v}_{3} ) \vert f ∈ F , \frac{{v}_{1} + {v}_{2} + {v}_{3}}{3} \cdot p \geq p \cdot n \} ,$$

where F denotes the list of faces. To avoid Z-fighting (e.g., depth fighting or stitching) during rendering between the shape S 602 and the mask M 604, the mask M 604 is scaled by twenty percent while keeping its center of mass the same, ensuring the mask M 604 completely envelopes the part of the shape S 602 above the plane P 606.

A second type of edit involves mesh sculpting. In this scenario, the mask M 608 is designed to represent a more precise edit where the user expects content to be created in a portion of space similar to the mask. Mesh sculpting generally involves more expertise and time from the user than coarse edits, but also provides more precise control over the generated content. As illustrated in FIG. 6, the mask M 608 is a tight fit over the shape S 602-no volume inside the mask M 608 is not also inside the shape S 602. To generate the masks M 608, a plane P 610, which is similar to the plane P 606, is sampled and each face that has its midpoint above the plane P 610 is selected, i.e.,

$$M = \{ f = ( {v}_{1} , {v}_{2} , {v}_{3} ) \vert f ∈ F , \frac{{v}_{1} + {v}_{2} + {v}_{3}}{3} \cdot p \geq p \cdot n \} ,$$

A third type of edit involves surface editing that supports local texture modifications. In this scenario, the user selects a surface patch and prompts the multiview inpainter module 122 to modify its texture. A vertex p in the shape S 602 and several cylinders with elliptical bases of of varying sizes, each centered on p, are sampled, which collectively are illustrated in FIG. 6 as volume C 614. The number of cylinders is uniformly sampled between three and six, the revolution axis is sampled on the unit sphere, the height and radii are sampled between 0.1 and 0.3 to generate the volume C 614. The faces whose midpoints fall within the volume C are selected to generate the mask M 612, i.e.,

$$M = \{ f = ( {v}_{1} , {v}_{2} , {v}_{3} ) \vert f ∈ F , \frac{{v}_{1} + {v}_{2} + {v}_{3}}{3} ∈ C \} ,$$

### Example Inpainting Procedure

The following discussion describes inpainting techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm, e.g., responsive to execution of the instructions. In portions of the following discussion, reference will be made to FIGS. 1-6.

FIG. 7 is a flow diagram depicting an algorithm as a step-by-step procedure 700 in an example implementation of operations performable for accomplishing a result of multiview inpainting of 3D objects. To begin, a processing device receives a first 3D object (e.g., a digital object 116), a mask (e.g., 3D mask 206) indicating a region of the first 3D object in which to inpaint a second 3D object, and a text description (e.g., prompt 208) of the second 3D object (block 702). The first 3D object is represented using meshes, Gaussian Splats, Neural Radiance Fields (NeRFs) or another 3D representation format.

A first machine-learning model generates multiple 2D views of the first 3D object and the mask (block 704). For example, the multiview generator 202 includes a machine-learning model that takes or generates at least four 2D images 210 of the first 3D object and the mask from different azimuth angles in a horizontal coordinate system around the first 3D object. The horizontal coordinate system is generally centered on the first 3D object. In one implementation, the 2D images 210 include a first two-by-two grid of four color images or views of the first 3D object not occluded by the mask and a second two-by-two grid of four black-and-white images or views of the mask in black-and-white.

A “machine-learning model” refers to a computer representation that is tunable (e.g., trained and retrained) based on inputs to approximate unknown functions. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “diffusion model” is a generative machine-learning model used for digital content creation, e.g., digital images. To train a diffusion model, noise is added to training data samples until the data within the training data samples is obscured. The diffusion model is then trained to reverse this process based on training data with a text prompt describing the digital content to be created to generate data samples as the digital content corresponding to the text prompt. Diffusion models are also distillable to decrease the number of parameters or inference steps, which, in some cases, enable these models to run locally on user devices.

The first machine-learning model then generates, in each of the 2D views, a third 3D object that includes the second 3D object inpainted on the first 3D object (block 706). For example, the multiview inpainter module 122 uses the diffusion model 212 to generate inpainted 2D images 214. In one implementation, the same machine-learning model generates the 2D images 210 and the inpainted 2D images 214. In another implementation, different machine-learning models are used to generate the 2D images 210 and the inpainted 2D images 214.

In at least one implementation, the first machine-learning model is a pretrained text-to-image diffusion model (e.g., diffusion model 212) that performs diffusion in a 4D latent space. This diffusion model includes a vector quantized variational autoencoder to encode the 2D images 210 of the digital object 116 and the 3D mask 206 into the 4D latent space and a decoder to convert the inpainted 2D images 214 from the 4D latent space into a red-green-pixel space.

The diffusion model 212, which is pretrained to generate images from text prompts, is fine-tuned using a data set of text prompts describing second 3D objects to inpaint on first 3D objects, images of the first 3D objects, and 3D masks indicating a relative positioning and size for each second 3D object to inpaint on a corresponding first 3D object. The 3D masks include coarse edit masks that envelope a portion of the first 3D objects to a side of (e.g., above) a plane passing through the first 3D objects. As described above, the coarse edits masks are defined as a convex hull of each face midpoint to the side of the plane. Another 3D mask type includes mesh sculpting masks with each face of the first 3D objects to the side of the plane passing through the first 3D objects. The mesh sculpting masks are defined by each face having a midpoint to the side of the plane. The 3D masks for fine-tuning purposes also include surface editing masks, which involve a surface patch of the first 3D objects. These surface editing masks are defined by each face having a midpoint within a volume generated from at least two cylinders with elliptical bases of varying sizes centered on a vertex in the first 3D objects.

A second machine-learning model reconstructs a 3D representation of the third 3D object from the multiple 2D views (block 708). For example, the reconstruction module 204 generates a 3D representation of the inpainted digital object 218 from the inpainted 2D images 214. The inpainted digital object 218 is represented using meshes, Gaussian Splats, NeRFs, or another 3D representation format. In at least one scenario, a representation format of the digital object 116 is different than the representation format of the inpainted digital object 218. The second machine-learning model is a reconstructor trained to generate a 3D representation of objects from multiple 2D views of objects. In one implementation, the inpainting system 120 also includes an optimization module 216 that applies an optimization procedure based on differentiable rendering to the inpainted digital object 218 to achieve geometric regularization and preserve at least one of a color, connectivity, or vector positioning of the digital object 116. In one implementation, the inpainting system 120 includes multiple reconstruction modules 204 and optimization modules 216 that are selected based on the representation format of the inpainted digital object 218.

The processing device then presents the 3D representation of the third 3D object for display in a user interface (block 710). For example, the inpainting system 120 provides an interactive application or user interface that allows users to load 3D digital objects, create masks with basic primitive objects, and visualize the results in near real-time (e.g., just a few seconds). In contrast to some conventional techniques that infer the area to be edited using attention weights from a prompt, the described inpainting system 120 allows users to provide or define the 3D masks 206 to more precisely control the positioning of the inpainting edits. Similarly, the inpainting system 120 also allows users to edit surface texture details by either adding new texture elements (e.g., facemask or saddle) or fixing artifacts in the texture (e.g., an object exhibiting inconsistent coloring).

### Example System and Device

FIG. 8 illustrates an example system 800 that includes an example computing device 802 that is representative of one or more computing systems and/or devices that implement the various techniques described herein. This is illustrated through the inclusion of the inpainting system 120. The computing device 802 is configurable, for example, as a server of a service provider, a device associated with a client (e.g., a client device), an on-chip system, and/or any other suitable computing device or computing system.

As illustrated, the example computing device 802 includes a processing device 804, one or more computer-readable media 806, and one or more I/O interface 808 that are communicatively coupled to one another. Although not shown, the computing device 802 further includes a system bus or other data and command transfer system that couples the various components from one to another. A system bus includes any one or combination of different bus structures, such as a memory bus or memory controller, a peripheral bus, a universal serial bus, and/or a processor or local bus that utilizes various bus architectures. Various other examples are also contemplated, such as control and data lines.

The processing device 804 represents the functionality of performing one or more operations using hardware. Accordingly, the processing device 804 is illustrated as including hardware element 810 that is configurable as processors, functional blocks, and so forth. This includes implementation in hardware as an application-specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 806 includes memory/storage 812 that stores executable instructions to cause the processing device 804 to perform operations. The computer-readable storage medium is configured for storing instructions that, responsive to execution by the processing device, cause the processing device to perform operations. The memory/storage 812 represents memory/storage capacity associated with one or more computer-readable media. The memory/storage 812 includes volatile media (such as random access memory (RAM)) and/or nonvolatile media (such as read-only memory (ROM), Flash memory, optical disks, magnetic disks, and so forth). The memory/storage 812 includes fixed media (e.g., RAM, ROM, a fixed hard drive, and so on) and removable media (e.g., Flash memory, a removable hard drive, an optical disc, and so forth). The computer-readable media 806 is configurable in various ways, as described below.

Input/output interface(s) 808 are representative of functionality to allow a user to enter commands and information to computing device 802 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in various ways, as described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. Computer-readable media includes a variety of media that are accessible by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal-bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium configured to transmit instructions to the hardware of the computing device 802, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representatives of modules, programmable device logic, and/or fixed device logic implemented in a hardware form that is employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module executable by the computing device 802 as software is achieved at least partially in hardware, e.g., through computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through a distributed system, such as over a “cloud” 814 via a platform 816 as described below.

Cloud 814 includes and/or represents platform 816 for resources 818. Platform 816 abstracts the underlying functionality of hardware (e.g., servers) and software resources of cloud 814. The resources 818 include applications and/or data that are utilizable while computer processing is executed on servers remote from the computing device 802. Resources 818 also include services provided over the Internet and/or through a subscriber network, such as a cellular or Wi-Fi network.

The platform 816 abstracts resources and functions to connect the computing device 802 with other computing devices. The platform 816 also abstracts the scaling of resources to provide a corresponding level of scale to meet the demand for the resources 818 implemented via the platform 816. Accordingly, in an interconnected device implementation, the implementation of functionality described herein is distributable throughout the system 800. For example, the functionality is implementable in part on the computing device 802 and via the platform 816 that abstracts the functionality of the cloud 814.

In implementations, the platform 816 employs a “machine-learning model” configured to implement the techniques described herein. A machine-learning model refers to a computer representation that is tunable (e.g., trained and retrained) based on inputs to approximate unknown functions. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Instead, the specific features and acts are disclosed as example forms of implementing the claimed invention.

What is claimed is:

1. A method comprising:
receiving, by a processing device, a first three-dimensional (3D) object, a mask indicating a region of the first 3D object in which to inpaint a second 3D object, and a text description of the second 3D object;
generating, by a first machine-learning model, multiple two-dimensional (2D) views of the first 3D object and the mask;
generating, by the first machine-learning model and in each of the multiple 2D views, a third 3D object that includes the second 3D object inpainted on the first 3D object;
reconstructing, by a second machine-learning model, a 3D representation of the third 3D object from the multiple 2D views; and
presenting, by the processing device, the 3D representation of the third 3D object for display in a user interface.

2. The method of claim 1, wherein the first machine-learning model is a pretrained text-to-image diffusion model configured to perform diffusion in a four-dimensional (4D) latent space, the diffusion model including a vector quantized variational autoencoder to encode the multiple 2D views of the first 3D object and the mask into the 4D latent space and a decoder to convert the multiple 2D views of the third 3D object from the 4D latent space into a red-green-pixel space.

3. The method of claim 2, wherein the pretrained text-to-image diffusion model is fine-tuned using a data set of text prompts describing second 3D objects to inpaint on first 3D objects, images of the first 3D objects, and 3D masks indicating a relative positioning and size for each second 3D object to inpaint on a corresponding first 3D object.

4. The method of claim 3, wherein the 3D masks include at least one of:
coarse edit masks that envelope a portion of the first 3D objects to a side of a plane passing through the first 3D objects, the coarse edits masks being defined as a convex hull of each face midpoint to the side of the plane;
mesh sculpting masks that include each face of the first 3D objects to the side of the plane passing through the first 3D objects, the mesh sculpting masks being defined by each face having a midpoint to the side of the plane; or
surface editing masks that include a surface patch of the first 3D objects, the surface editing masks being defined by each face having a midpoint within a volume generated from at least two cylinders with elliptical bases of varying sizes centered on a vertex in the first 3D objects.

5. The method of claim 1, wherein the multiple 2D views of the first 3D object include at least four 2D views of the first 3D object and the mask from different azimuth angles in a horizontal coordinate system around the first 3D object.

6. The method of claim 5, wherein the multiple 2D views include:
a first two-by-two grid of four 2D views of the first 3D object not occluded by the mask in color; and
a second two-by-two grid of four 2D views of the mask in black-and-white.

7. The method of claim 1, wherein:
the first 3D object is represented using meshes, Gaussian Splats, or Neural Radiance Fields (NeRFs); and
the third 3D object is represented using the meshes, the Gaussian Splats, or the NeRFs.

8. The method of claim 7, wherein a representation format of the first 3D object is different than the representation format of the third 3D object.

9. The method of claim 1, wherein the second machine-learning model is a reconstructor trained to generate a 3D representation of objects from multiple 2D views of the objects.

10. A system comprising:
a memory component; and
a processing device coupled to the memory component, the processing device configured to:
receive a first three-dimensional (3D) object, a mask indicating a region of the first 3D object in which to inpaint a second 3D object, and a text description of the second 3D object;
generate, by a first machine-learning model, multiple two-dimensional (2D) views of the first 3D object and the mask;
generate, by the first machine-learning model and in each of the multiple 2D views, a third 3D object that includes the second 3D object inpainted on the first 3D object;
reconstruct, by a second machine-learning model, a 3D representation of the third 3D object from the multiple 2D views; and
present the 3D representation of the third 3D object for display in a user interface.

11. The system of claim 10, wherein:
the first machine-learning model is a pretrained text-to-image diffusion model trained to generate 2D images of objects from text descriptions; and
the second machine-learning model is a reconstructor trained to generate a 3D representation of objects from multiple 2D views of the objects.

12. The system of claim 10, wherein the processing device is further configured to apply an optimization procedure based on differentiable rendering to the third 3D object to achieve geometric regularization of the third 3D object and preserve at least one of a color, connectivity, or vector positioning of the first 3D object.

13. The system of claim 10, wherein the multiple 2D views of the first 3D object include at least four 2D views of the first 3D object and the mask from different azimuth angles and one or more elevation angles in a horizontal coordinate system around the first 3D object.

14. The system of claim 13, wherein the different azimuth angles are separated by ninety degrees to obtain the multiple 2D views from different sides of the first 3D object.

15. The system of claim 13, wherein the multiple 2D views include:
a first two-by-two grid of four 2D views of the first 3D object not occluded by the mask in color; and
a second two-by-two grid of four 2D views of the mask in black-and-white.

16. The system of claim 10, wherein the second 3D object is identified via a text or audio input.

17. One or more non-transitory computer-readable storage media storing instructions that, responsive to execution by a processing device, causes the processing device to perform operations comprising:
receiving a first three-dimensional (3D) object, a mask comprising one or more primitive 3D shapes that indicate a region of the first 3D object in which to inpaint a second 3D object, and a text description of the second 3D object;
generating, by a first machine-learning model, multiple two-dimensional (2D) views of the first 3D object and the mask from different perspectives;
generating, by the first machine-learning model and in each of the multiple 2D views, a third 3D object that includes the second 3D object inpainted on the first 3D object;
reconstructing, by a second machine-learning model, a 3D representation of the third 3D object from the multiple 2D views; and
presenting, by the processing device, the 3D representation of the third 3D object for display in a user interface.

18. The one or more non-transitory computer-readable storage media of claim 17, wherein the first machine-learning model is a pretrained text-to-image diffusion model that is fine-tuned using a data set of text prompts describing second 3D objects to inpaint on first 3D objects, images of the first 3D objects, and 3D masks indicating a relative positioning and size for each second 3D object to inpaint on a corresponding first 3D object.

19. The one or more non-transitory computer-readable storage media of claim 18, wherein the 3D masks include at least one of:
coarse edit masks that envelope a portion of the first 3D objects to a side of a plane passing through the first 3D objects, the coarse edits masks being defined as a convex hull of each face midpoint to the side of the plane;
mesh sculpting masks that include each face of the first 3D objects to the side of the plane passing through the first 3D objects, the mesh sculpting masks being defined by each face having a midpoint to the side of the plane; or
surface editing masks that include a surface patch of the first 3D objects, the surface editing masks being defined by each face having a midpoint within a volume generated from at least two cylinders with elliptical bases of varying sizes centered on a vertex in the first 3D objects.

20. The one or more non-transitory computer-readable storage media of claim 17, wherein the multiple 2D views of the first 3D object include four 2D views of the first 3D object and the mask from different azimuth angles in a horizontal coordinate system around the first 3D object with:
a first two-by-two grid of the four 2D views of the first 3D object not occluded by the mask in color; and
a second two-by-two grid of the four 2D views of the mask in black-and-white.
